(19) United States
(12) Patent Application Publication
(10) Pub. No.: US 2010/0139225 A1
(43) Pub. Date: Jun. 10, 2010

(54) FILTER HOUSING AND PRODUCTION METHOD

(76) Inventors: John Ronald Mammarella, Windsor (CA); Jeffrey Joseph Powell, Belle River (CA); Lisa Whaley, Wheatley (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/518,192

(22) PCT Filed: Dec. 7, 2007
(86) PCT No.: PCT/EP2007/063508

§ 371 Date: Jan. 7, 2010

Related U.S. Application Data
(60) Provisional application No. 60/869,193, filed on Dec. 8, 2006.

(51) Int. Cl. B01D 46/00; B01D 35/30; B29C 45/00

(52) U.S. Cl. 55/493; 55/490; 264/328.1; 264/328.8

(57) ABSTRACT

The present invention relates to a filter housing (1) for the accommodation of at least one air filter element, in particular for a fresh air apparatus of an internal combustion machine, with two shell bodies (2, 3) made of synthetic material which each have a flange (6, 7) and which can be fastened to each other in the area of the flange (6, 7) by means of fastening elements (8). The fastening elements (8) are produced together with each shell body (2, 3) in a common mold by means of injection molding.

The present invention relates to a filter housing for accommodation of at least one air filter element, in particular for a fresh air apparatus of an internal combustion engine. The invention relates in addition to a method for producing such a filter housing.

A filter housing consists typically of two shell bodies which are normally made of plastic. The two shell bodies each have a flange and can be fastened to each other in the area of these flanges by means of fastening elements. For this, for example, screws can be used to screw the shell bodies together. It is principally also possible to attach elastic clamps, clips, or retainers to the flanges to fix the shell bodies to each other. For this, such fitting elements are typically made of metal and are attached later to the shell bodies.

The present invention is concerned with the problem to propose, for a filter housing or for an associated production method, respectively, an improved embodiment which is, in particular, characterized in that the expenditure for producing the filter housing is reduced so that it can be produced in particular more inexpensive.

This problem is solved according to the invention by the subject matters of the independent claims. Advantageous embodiments are subject matter of the dependent claims.

The invention is based on the general idea to produce each shell body together with the respective fastening elements in a common mold by means of injection molding. Hereby, the respective fastening elements are already located on the shell body after the injection molding of the shell body so that a separate mounting of the fastening elements to the shell body can be eliminated. Hereby, a manufacturing step can be cut out which makes the production of the filter housing more inexpensive.

Particularly advantageous is an embodiment in which at least one of the fastening elements is formed as a clip which is arranged on one of the flanges and which interacts with a latching contour and which then forms a complementary fastening element. The one of the shell bodies is then produced together with the at least one clip in a common mold by means of injection molding while the other shell body is produced together with the at least one latching contour in a common mold by means of injection molding. Such clips, which interact with a latching contour, are relatively easy to operate manually, whereby the filter housing can be opened and closed in a particularly simple manner.

Principally, the at least one clip can be integrally formed on the respective shell body in such a manner that it can be bent spring-elastically to a degree that it can be latched at the respective latching contour. The desired bending elasticity can be achieved, for example, by an accordingly reduced material thickness in the area of the clip. In particular, a film hinge can be injection molded.

In another embodiment it can be provided to mold the at least one clip on the shell body in such a manner that it is supported pivotably displaceable in a fitting integrally formed on the respective shell body. Here, it is principally possible to injection mold the clip during the production of the respective shell body in such a manner that it is at first fixed connected with the fitting by means of at least one predetermined breaking point, wherein this predetermined breaking point breaks upon the first pivoting movement of the clip. Alternatively, the clip can be injection molded from the beginning in such a manner that it forms a separate component from the beginning with respect to the fitting and that it is supported pivotably displaceable in the fitting. The introduced alternatives allow a simple handling of the fastening elements for opening and closing of the filter housing.

Further important features and advantages of the invention arise from the sub-claims, the drawings, and the associated description of the figures by means of the drawings.

It is to be understood that the aforementioned features and the features yet to be described hereinafter are not applicable only in the respective stated combination, but also in other combinations or on its own without departing from the scope of the present invention.

Preferred exemplary embodiments of the invention are illustrated in the drawings and are explained in the following description in more detail, wherein the same reference numbers refer to the same, or similar, or functionally identical components.

Schematically, in the figures:

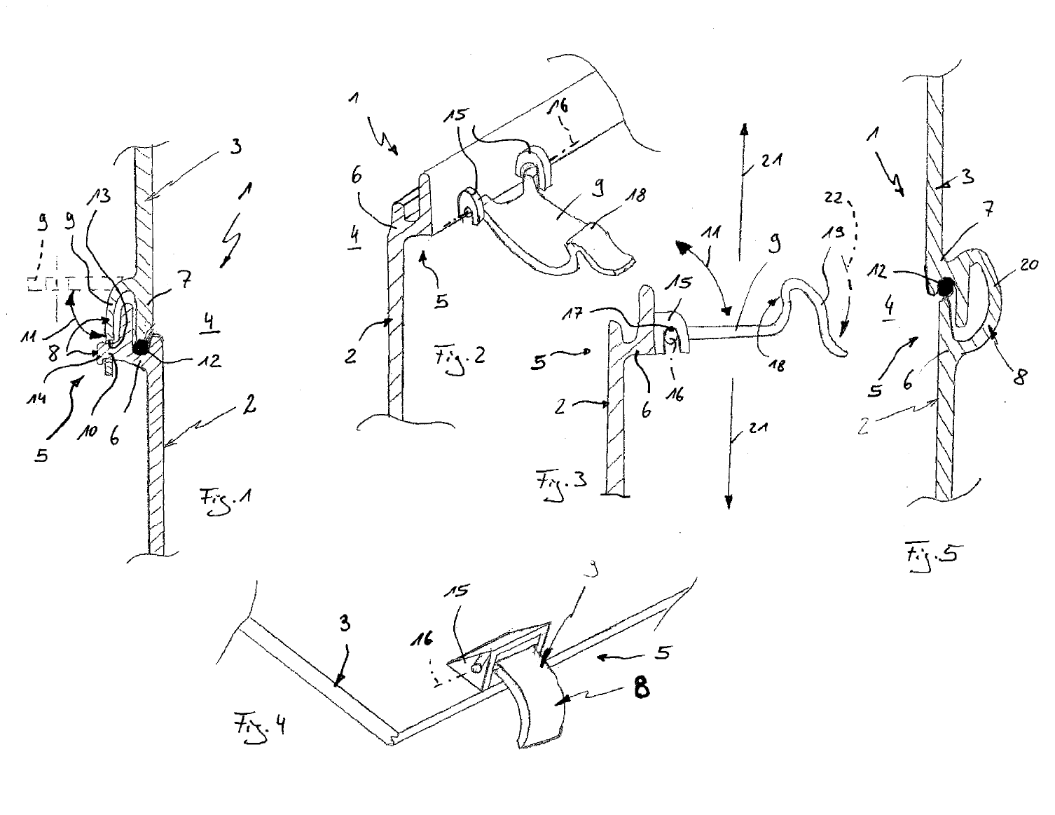

FIG. 1 shows a sectional view of a filter housing in the area of a joint,

FIG. 2 shows a cross-sectional perspective view of a shell body in the area of the joint, but for a different embodiment,

FIG. 3 shows a sectional view of the embodiment according to FIG. 2,

FIG. 4 shows a perspective view of a shell body in the area of the joint for a further embodiment,

FIG. 5 shows a sectional view of the filter housing in different area of the joint.

According to FIGS. 1 to 5, a filter housing 1 comprises two shell bodies 2 and 3. In the assembled condition, the two shell bodies 2, 3 enclose an interior 4 for accommodation of a not-shown air filter element. The filter housing 1 can be used, for example, for a fresh air apparatus of an internal combustion engine which can be arranged, in particular, in a motor vehicle. Of the filter housing 1, only a small area is illustrated here in which the two shell bodies 2, 3 are connected with one another in the assembled condition, thus with a closed housing 1. Here, a joint is defined which is denoted hereinafter with 5. In the area of this joint 5, each of the shell bodies 2, 3, have a flange 6 or 7, respectively. The flanges 6, 7 define the joint 5. In the area of these flanges 6, 7, the two shell bodies 2, 3 can be fastened to each other by means of fastening elements 8. In the shown example, the flanges 6, 7 engage with each other in the manner of a tongue and groove joint. In FIG. 1, in the tongue and groove joint of the flanges 6, 7, in addition, a sealing element 12 is arranged to improve the airtight connection of the two shell bodies 2, 3.

The shell bodies 2, 3 consist of plastic, whereby the filter housing 1 can be realized relatively inexpensive. According to the invention, the fastening elements 8 are also made of plastic. Here, the fastening elements 8 are produced together with the respective shell body 2, 3 in a common injection mold by means of injection molding.

Particularly advantageous for this are the embodiments shown here in which at least one of the fastening elements 8 is formed as a clip or lever or retainer and is denoted with 9. Said clip 9 is formed or arranged, respectively, on one of the flanges, here on the flange 7 of the upper shell body 3. For fastening the two shell bodies 2, 3 to one another, the clip 9 interacts with a complementary fastening element 8 which is designed as a latching contour 10 and which is formed on the flange 6 of the other shell body 2. For this, the production of the two shell bodies 2, 3 is advantageously carried out in such a manner that the one shell body 3 is produced together with the at least one clip 9 in a common mold by means of injection molding. Further, the other shell body 2 is produced together with at least one latching contour 10 in a common mold by means of injection molding.

FIG. 1 shows an embodiment in which the at least one clip 9 is integrally formed on the respective shell body 3. At the same time, the clip is designed in such a manner that it can be bent spring-elastically. In particular, it can be bent spring-elastically to a degree that it can be latched at the respective latching contour 10. FIG. 1 shows the clip 9 with a solid line in the latched condition and with a broken line in a released initial condition. A double arrow 11 indicates the resilient deformability of the clip 9. In the example, the clip 9 is bent over by ca. 90° for shifting it into the latched condition. It is clear that other embodiments with a different, in particular, smaller bending angle are also conceivable. For example, the shown condition can also be the undeformed condition so that the clip 9 must temporarily be bent open for latching and unlatching.

In the embodiment shown in FIG. 1, the respective clip 9 has a latching opening 13 in which a latching nose 14 of the latching contour 10 can latch. Hereby, a particularly effective latching can be realized by means of which the two shell bodies 2, 3 can be fixed positively locking to one another.

FIGS. 2 and 3 show another embodiment in which the respective clip 9 is supported pivotably displaceable about a pivoting axis 16 in a fitting 15. For this, the respective fitting 15 is integrally formed on the respective shell body 2. The same applies to the embodiment shown in FIG. 4. There, the clip 9 is also supported pivotably displaceable about a pivoting axis 16 in a fitting 15 integrally formed on the shell body 3.

In the embodiment shown in the FIGS. 2 and 3, the clip 9 is injection molded during the production of the respective shell body 2 in such a manner that the clip is subsequently fixed connected with the fitting 15 by means of a predetermined breaking point 17 which is symbolically indicated in FIG. 3 by means of a point. This predetermined breaking point 17 can be broken upon the first pivoting displacement of the clip 9, whereby the clip 9 is separated from the shell body 2 and the free pivotable displaceability of the clip 9 is realized. Forming such a predetermined breaking point 17 can simplify the production of the common mold of shell body 2 and clip 9. In FIG. 3, a possible application of force for breaking the clip 9 loose is indicated by means of the arrows 21. The pivotable displaceability is indicated again by means of a double arrow 11. A further arrow 22, indicated with a broken line, symbolizes the spring-elastic actuation of the spring section 18 at the extension or projection 19 thereof.

In the embodiment shown in FIG. 4, the clip 9 is injection molded on the respective shell body 3 in such a manner that it forms a separate component from the beginning which is already supported pivotably displaceable in the fitting 15. Particularly advantageous for both variants is an embodiment in which the clip 9 is formed and injection molded in such a manner that it is captively arranged in the fitting 15 by means of positive locking.

In the embodiment of FIGS. 2 and 3, on the clip 9, a spring section 18 is formed which, at the other flange, can engage in a positively locking manner behind the latching contour 10 which is formed complementary to the spring section. An extension 19 of this spring section 18 simplifies the opening and closing or the latching and unlatching, respectively, of the clip 9, which simplifies the handling of the fastening elements 8.

According to FIG. 5, at least one of the fastening elements can be designed as a hinge 20. This hinge 20 is integrally formed here on both shell bodies 2, 3 and allows pivoting of the two shell bodies 2, 3 relative to each other so as to be able to open and close the filter housing 1. The hinge 20 is formed by means of an appropriate resilient rib-shaped section which, for example, has a reduced wall thickness. In particular, the hinge 20 can be a film hinge. For a filter housing 1 with a rectangular cross section, such a hinge 20 is, or such hinges 20 are, respectively, arranged or formed, respectively, only on one side of the filter housing 1 to be able to pivot the two shell bodies 2, 3 about a pivoting axis extending along this housing side. At least one of the three other housing sides can then have at least on of the pairs of interacting fastening elements 8 such as, for example, a clip 9 and a latching contour 10.

In case such a hinge 20 is provided, both shell bodies 2, 3 together with all fastening elements 8 can be injection molded in a common mold, whereby the production cost can be reduced again.

1. A filter housing for the accommodation of at least one air filter element, comprising:
two shell bodies made of plastic which each have a flange and which are fastened to each other in the area of the flanges by means of fastening elements,
wherein the fastening elements are injection molded parts produced together with the respective shell body in a common mold.

2. The filter housing according to claim 1, wherein:
i. at least one of the fastening elements is formed as at least one clip which is arranged on one of the flanges and which interacts for fastening the shell bodies to each other with a latching contour which is formed on the other flange,
ii. that the one shell body is produced together with the at least one clip in a common mold by means of injection molding, and
iii. that the other shell body is an injection molded part produced together with the at least one latching contour in a common mold.

3. The filter housing according to claim 2, wherein the at least one clip is integrally formed on the respective shell body and is bent spring-elastically to a degree such that the at least one clip latches at the respective latching contour.

4. The filter housing according to claim 3, wherein the at least one clip has a latching opening with which upon latching, a latching nose of the respective latching contour engages.

5. The filter housing according to claim 2, wherein the at least one clip is supported pivotably displaceable in a fitting which is integrally formed on the respective shell body.

6. The filter housing according to claim 5, wherein the at least one clip is an injection molded part such that the at least one clip is fixedly connected with the fitting by means of at least one predetermined breaking point, wherein the at least one predetermined breaking point breaks upon a first pivoting displacement of the clip.

7. The filter housing according to claim 5, wherein the at least one clip is a separate injection molded component on the shell body such that the at least one clip is supported pivotably displaceable in the fitting.

8. The filter housing according to claim 5, wherein the at least one clip is arranged captively in the fitting by positive locking.

9. The filter housing according to claim 1, wherein at least one of the fastening elements is a hinge which is integrally formed on both shell bodies and allows pivoting of the shell bodies relative to each other for opening and closing the filter housing.

10. The filter housing according to claim 9, wherein both shell bodies are injection molded together with the fastening elements in a common mold.

11. A method for producing a filter housing for the accommodation of at least one air filter element, comprising:
providing the filter housing with two shell bodies which each have a flange and which can be fastened to each other in the area of the flanges by means of fastening elements, and
producing the fastening elements together with the respective shell body in a common mold by means of injection molding.

12. (canceled)

13. The method according to claim 11, further comprising:
i. forming at least one of the fastening elements as at least one clip which is arranged on one of the flanges and which interacts for fastening the shell bodies to each other with a latching contour which is formed on the other flange,
ii. producing the one shell together with the at least one clip in a common mold by means of injection molding, and
iii. producing the other shell body together with the at least one latching contour in a common mold by means of injection molding.

14. The method according to claim 13, further comprising forming the at least one clip integrally on the respective shell body, and wherein the at least one clip is bent spring-elastically to a degree such that the at least one clip latches at the respective latching contour.

15. The method according to claim 14, wherein the at least one clip has a latching opening with which upon latching, a latching nose of the respective latching contour engages.

16. The method according to claim 13, further comprising supporting the at least one clip to be pivotably displaceable in a fitting which is integrally formed on the respective shell body.

17. The method according to claim 16, further comprising producing the at least one clip during production of the respective shell body as an injection molded part such that the at least one clip is fixedly connected with the fitting by means of at least one predetermined breaking point, wherein the at least one predetermined breaking point breaks upon a first pivoting displacement of the clip.

18. The method according to claim 16, further comprising producing the at least one clip (9) during production of the respective shell body as an injection molded separate component on the shell body such that the at least one clip is supported pivotably displaceable in the fitting.

19. The method according to claim 16, further comprising arranging the at least one clip captively in the fitting by positive locking.

20. The method according to claim 11, wherein at least one of the fastening elements is a hinge which is integrally formed on both shell bodies and allows pivoting of the shell bodies relative to each other for opening and closing the filter housing.

21. The filter housing according to claim 20, further comprising injection molding both shell bodies together with the fastening elements in a common mold.
